(19) United States
(12) Patent Application Publication
(10) Pub. No.: US 2025/0036065 A1
(43) Pub. Date: Jan. 30, 2025

(54) STATIC ELIMINATION DEVICE AND MEDIUM PROCESSING SYSTEM USING SAME

(71) Applicant: FUJIFILM Business Innovation Corp., Tokyo (JP)

(72) Inventors: Katsumi TANAKA, Kanagawa (JP); Tomokazu KURITA, Kanagawa (JP); Satoshi SHIGEZAKI, Kanagawa (JP); Koichiro YUASA, Kanagawa (JP); Jun KUWABARA, Kanagawa (JP); Hirotaka TANAKA, Kanagawa (JP)

(73) Assignee: FUJIFILM Business Innovation Corp., Tokyo (JP)

(21) Appl. No.: 18/430,537

(22) Filed: Feb. 1, 2024

(30) Foreign Application Priority Data
Jul. 25, 2023 (JP) 2023-120533

(51) Int. Cl. G03G 21/06; G03G 15/00

(52) U.S. Cl. CPC G03G 21/06; G03G 15/6552; G03G 15/80; G03G 2215/00654

(57) ABSTRACT

A static elimination device includes static elimination rolls in a paired configuration that respectively have roll bodies continuously extending along an axial direction intersecting a moving direction of a medium and that eliminate static electricity by moving the medium in a nipped state, a static elimination power source that applies a static elimination voltage to at least one static elimination roll of the static elimination rolls in the paired configuration, and a regulating unit that passes through a non-contact portion formed at a part of a contact region of the static elimination rolls in the paired configuration in the axial direction and that extends to a front and a back in the moving direction of the medium to regulate the moving direction of the medium.

### CROSS-REFERENCE TO RELATED APPLICATIONS

This application is based on and claims priority under 35 USC 119 from Japanese Patent Application No. 2023-120533 filed Jul. 25, 2023.

### BACKGROUND

### (i) Technical Field

The present invention relates to a static elimination device and a medium processing system using the static elimination device.

### (ii) Related Art

In the related art, as a static elimination device of this type, for example, a device described in JP2022-161567A is already known.

JP2022-161567A includes two static elimination rolls and a peeling member. Voltages having potentials different from each other are applied to the two static elimination rolls, and the static elimination rolls are configured to perform static elimination by reducing a charging amount of paper as the paper passes therethrough. The peeling member is provided to be in close contact with a surface of one static elimination roll of the two static elimination rolls and is configured to peel off paper adhering to the static elimination roll with the rotation of the static elimination roll.

### SUMMARY

Aspects of non-limiting embodiments of the present disclosure relate to a static elimination device and a medium processing system using the static elimination device that maintain a static elimination action with respect to a medium well and that effectively suppress winding of the medium around static elimination rolls without damaging surfaces of the static elimination rolls in a paired configuration.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a static elimination device including static elimination rolls in a paired configuration that respectively have roll bodies continuously extending along an axial direction intersecting a moving direction of a medium and that eliminate static electricity by moving the medium in a nipped state, a static elimination power source that applies a static elimination voltage to at least one static elimination roll of the static elimination rolls in the paired configuration, and a regulating unit that passes through a non-contact portion formed at a part of a contact region of the static elimination rolls in the paired configuration in the axial direction and that extends to a front and a back in the moving direction of the medium to regulate the moving direction of the medium.

### BRIEF DESCRIPTION OF THE DRAWINGS

Exemplary embodiment(s) of the present invention will be described in detail based on the following figures, wherein:

FIG. 1A is an explanatory view showing an outline of an exemplary embodiment of a medium processing system including a static elimination device to which the present invention is applied, FIG. 1B is an arrow view that is viewed from a B-direction in FIG. 1A, and FIG. 1C is a sectional view taken along line C-C in FIG. 1A;

FIG. 2 is an explanatory view showing an overall configuration of a medium processing system according to exemplary embodiment 1;

FIG. 3 is an explanatory view showing an example of an image forming device used in the medium processing system according to FIG. 2;

FIG. 4 is an explanatory view showing an outline of a static elimination unit used in the medium processing system according to FIG. 2;

FIG. 5 is an explanatory view showing a configuration example of a static elimination device according to FIG. 4;

FIG. 6A is a perspective view showing major parts of a contact-type static elimination device used in exemplary embodiment 1, and FIG. 6B is an arrow view that is viewed from the B-direction in FIG. 6A;

FIG. 7A is a sectional view of the contact-type static elimination device used in exemplary embodiment 1, which is taken along line VII-VII in FIG. 6B, FIG. 7B is a sectional view taken along line B-B in FIG. 7A, and FIG. 7C is an explanatory view of major parts, which shows behavior of a medium passing through the contact-type static elimination device;

FIG. 8A is an explanatory view schematically showing a static elimination action by the contact-type static elimination device, FIG. 8B is an explanatory view schematically showing a basic static elimination action by the contact-type static elimination device shown in FIG. 5 and a non-contact-type static elimination device, and FIG. 8C is an explanatory view schematically showing a static elimination action with respect to a width direction of the medium by the contact-type static elimination device according to the present exemplary embodiment;

FIG. 9A is an explanatory view showing major parts of modification embodiment 1 of the contact-type static elimination device used in exemplary embodiment 1, and FIG. 9B is an explanatory view showing major parts of modification embodiment 2 of the contact-type static elimination device;

FIG. 10 is an explanatory view showing major parts of a static elimination device according to exemplary embodiment 2;

FIG. 11A is a perspective view showing major parts of a contact-type static elimination device used in exemplary embodiment 2, and FIG. 11B is an arrow view that is viewed from the B-direction in FIG. 11A; and

FIG. 12A is an explanatory view schematically showing the static elimination action with respect to the medium which has passed through a first static eliminator of the contact-type static elimination device, and FIG. 12B is an explanatory view schematically showing the static elimination action with respect to the medium which has passed through a second static eliminator of the contact-type static elimination device.

### DETAILED DESCRIPTION

### Outline of Exemplary Embodiment

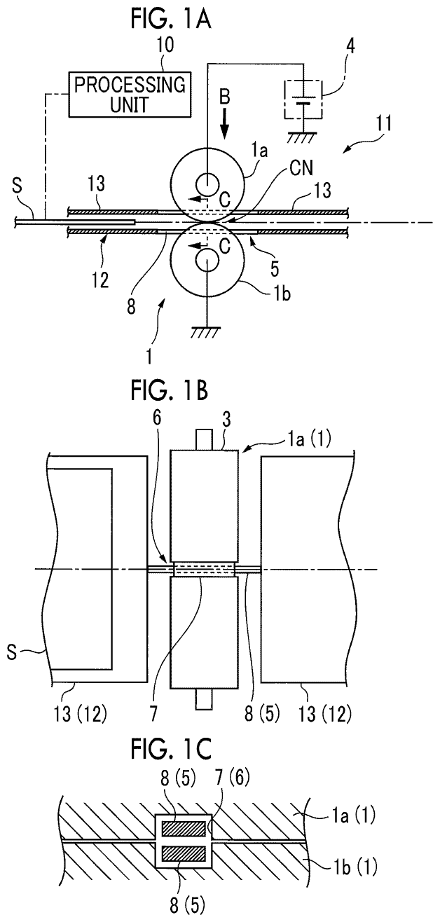

FIG. 1A shows an outline of an exemplary embodiment of a medium processing system to which the present invention is applied.

In FIG. 1A, the medium processing system includes a processing unit 10 that performs processing that involves charging on a moving medium S and a static elimination device 11 that eliminates static electricity by passing the medium S therethrough.

This type of medium processing system may include the processing unit 10 that requires a static elimination action by the static elimination device 11, and the processing unit 10 broadly includes a device that performs processing that involves charging on the transported medium S (for example, processing of transferring an image to the medium S by applying a transfer electric field or the like). In addition, the medium processing system is not limited to an aspect in which the processing unit 10 and the static elimination device 11 have separate unit configurations, and an aspect of being incorporated into an identical unit is also included.

In addition, in the present example, as shown in FIGS. 1A to 1C, the static elimination device 11 includes static elimination rolls 1 in a paired configuration (specifically, 1a and 1b) that each have a roll body 3 which continuously extends along an axial direction intersecting a moving direction of the medium S and that eliminate static electricity by moving the medium S in a nipped state, a static elimination power source 4 that applies a static elimination voltage to at least one static elimination roll (for example, 1a) of the static elimination rolls 1 in a paired configuration, and a regulating unit 5 that passes through a non-contact portion 6 formed at a part of a contact region CN of the static elimination rolls 1 in a paired configuration in the axial direction and that extends to the front and the back in the moving direction of the medium S to regulate the moving direction of the medium S.

In such a technical unit, an aspect in which the static elimination rolls 1 (1a and 1b) in a paired configuration each have the roll body 3 that continuously extends in the axial direction is assumed. For this reason, an aspect in which a plurality of roll bodies are divided in the axial direction with respect to a rotating shaft and are arranged, like a transport roll that transports the medium S, is excluded.

In addition, an electric field for static elimination is required to be applied to the static elimination rolls 1 (1a and 1b) in a paired configuration in a case where the medium S passes, for example, the static elimination power source 4 that applies a static elimination voltage to one static elimination roll 1a (or 1b) is provided, and the static elimination roll 1b (or 1a) on a side where a static elimination voltage is not applied may be grounded. It is evident that the static elimination voltage may be distributed and applied to both the static elimination rolls 1a and 1b in a paired configuration.

Further, the regulating unit 5 broadly includes a unit that regulates a transport direction of the medium S that passes through the static elimination rolls 1 in a paired configuration.

However, the non-contact portion 6 may be formed at a part of the contact region CN of the static elimination rolls 1 in a paired configuration in the axial direction, and the regulating unit 5 may extend to the front and the back in the moving direction of the medium S to pass through the non-contact portion 6.

Since the medium S may be wound around any of the static elimination rolls 1 in a paired configuration in the present example, for example, an aspect in which the regulating units 5 are provided in a pair at a front surface side and a back surface side of the medium S is preferable. However, for example, since the static elimination roll 1b on a ground side of the static elimination rolls 1 (1a and 1b) in a paired configuration tends to wind easily compared to the static elimination roll 1a on a side where a static elimination voltage is applied, for example, the regulating unit 5 may be provided only on a side of the static elimination roll 1b on the ground side.

In a case where the charged medium S passes through the static elimination rolls 1 (1a and 1b) in a paired configuration in such a static elimination device 11, the medium S is transported in a nipped state in the contact region CN of the static elimination rolls 1 in a paired configuration. In this case, since a static elimination voltage from the static elimination power source 4 is applied to at least one of the static elimination rolls 1 in a paired configuration, a region of the medium S, which passes through the contact region CN, is statically eliminated. However, since a region of the medium S, which passes through the non-contact portion 6 of the static elimination rolls 1 in a paired configuration, does not come into contact with the roll bodies 3 of the static elimination rolls 1, the region is not statically eliminated directly and is statically eliminated indirectly by an amount that a charge in the medium S is attracted toward a static elimination part of a region other than the non-contact portion 6.

In addition, although the region of the medium S, which passes through the contact region CN of the static elimination rolls 1 in a paired configuration, may be wound around any one of the static elimination roll 1a or 1b, a region of the medium S, which corresponds to the non-contact portion 6, abuts against the regulating unit 5 arranged in the non-contact portion 6 even in a case where the medium S is wound around any one of the static elimination roll 1a or 1b in the contact region CN. For this reason, a leading end portion of the medium S wound around the static elimination roll 1 (1a or 1b) is peeled off from the static elimination roll 1 by the regulating unit 5, and the medium S is transported toward the transport direction regulated by the regulating unit 5.

Next, for example, a representative aspect or a preferable aspect of the static elimination device according to the present exemplary embodiment will be described.

First, a bridging member 8 that bridges between fixing units 12 at the front and the back with the contact region CN of the static elimination rolls 1 in a paired configuration interposed between the fixing units will be given as an aspect of the regulating unit 5.

In the present example, the fixing units 12 may be units fixedly provided at positions determined in advance, for example, and consist of guide members 13 in a paired configuration that guide a movement path of the medium S, and the bridging member 8 is configured integrally with the guide members 13 in a paired configuration. Herein, the bridging member 8 may be a structure integrated in advance with the guide members 13 which are the fixing units 12 or may be a separate member from the guide members 13, which are the fixing units 12, but integrally fixed to each other later.

In addition, as another aspect of the regulating unit 5, as shown in FIGS. 1B and 1C, an aspect in which ring-shaped concave grooves 7 facing each other are provided in parts of surfaces of the static elimination rolls 1 in a paired configuration in the axial direction, respectively, and the regulating unit passes between the concave grooves 7 of the static elimination rolls 1 in a paired configuration as the non-contact portion 6 is given.

In the present example, although a rectangular shape, a semi-circular shape, a semi-elliptical shape, or the like may be selected as appropriate as a sectional shape of the concave groove 7, for example, an aspect of being a rectangular shape in cross section is preferable from a perspective of securing a wide sectional space.

Further, for example, the regulating unit 5 is preferably arranged in a state of not protruding from a surface of the concave groove 7 in a range of the contact region CN of the static elimination rolls 1 in a paired configuration such that a contact state between peripheral surfaces of the roll bodies 3 and the medium S is not impaired in a case where the regulating unit 5 passes through the static elimination rolls 1 in a paired configuration.

In addition, although a material for the regulating unit 5 may be selected as appropriate, for example, the material is preferably configured by an insulating material from a perspective of suppressing current leakage via the regulating unit 5.

Further, although a sectional shape of the regulating unit 5 may be selected as appropriate, for example, an aspect in which the regulating unit is configured in a rectangular shape in cross section or a circular shape in cross section is preferable in consideration of ease of arranging in the non-contact portion 6 or a contact resistance with the medium S.

In addition, in terms of layout of the regulating unit 5, for example, the regulating unit 5 is preferably arranged in a region though which all media S to be used pass. For example, in terms of an aspect in which the medium S moves with a center in an intersection direction intersecting the moving direction of the medium S as a reference line, the regulating unit 5 may be arranged in a place including the reference line. The same applies to an aspect in which the reference line is one side edge portion of the medium S in the intersection direction.

Further, it is not required to have one set of static elimination rolls 1 in a paired configuration, and an aspect in which a plurality of sets are provided in the moving direction of the medium S is also included.

In the present example, for example, an aspect in which the regulating unit 5 is provided for each set of static elimination rolls 1 in a paired configuration and the regulating unit 5 of each set is arranged to be biased in a direction intersecting the moving direction of the medium S is preferable. In the aspect in which there is one set of static elimination rolls 1 in a paired configuration, a region of the medium S, which corresponds to the non-contact portion 6 of the static elimination rolls 1, does not directly receive a static elimination action by the static elimination rolls 1. On the contrary, in the present example, for example, while a region of the medium S, which corresponds to the non-contact portion 6 of the static elimination rolls 1 positioned in a preceding stage, does not directly receive the static elimination action, a non-static elimination action portion of the medium S directly receives the static elimination action by passing through the contact region CN of the static elimination rolls 1 positioned in a subsequent stage. For this reason, in the aspect of passing through the plurality of sets of static elimination rolls 1, it is possible to apply the static elimination action to the entire region of the medium S.

Hereinafter, the present invention will be described in more detail based on the exemplary embodiments shown in the accompanying drawings.

### Exemplary Embodiment 1

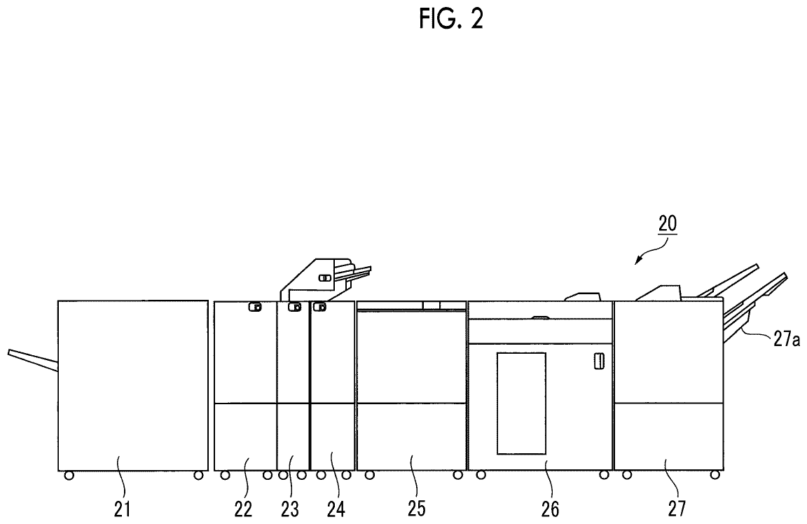

FIG. 2 is an explanatory view showing an overall configuration of a medium processing system according to exemplary embodiment 1.

### Configuration Example of Medium Processing System

In FIG. 2, a medium processing system 20 includes an image forming device 21 that forms an image on a medium, a first post-processing device 22 that performs post-processing determined in advance on the medium which has passed through the image forming device 21, an interposer 23 that inserts cardboard, a static elimination unit 24 that statically eliminates the charged medium, an inspection device 25 that inspects the image on the statically eliminated medium, a stacker 26 that accommodates the medium on which the image is formed therein, and a second post-processing device 27 that performs post-processing determined in advance on the medium on which the image is formed. The configuration example of the medium processing system 20 is not limited to the aspect shown in FIG. 2, and it is evident the configuration example can be subjected to design changes as appropriate.

### Overall Configuration of Image Forming Device

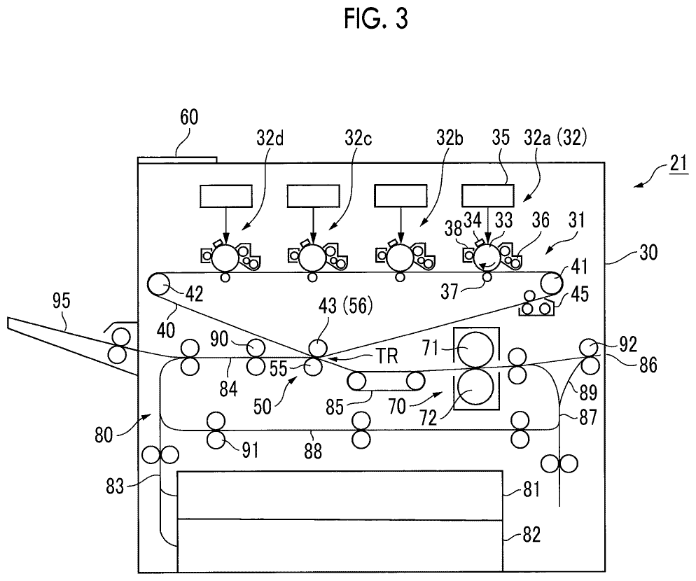

FIG. 3 shows an overall configuration of the image forming device 21.

In FIG. 3, in a basic configuration of the image forming device 21, for example, an image forming engine 31 for forming a plurality of color component images is mounted in a device housing 30, and a medium transport system 80 that transports a medium to the image forming engine 31 below the image forming engine 31 and a fixing device 70 that fixes an image formed by the image forming engine 31 to a medium are included.

In the present example, the image forming engine 31 includes image forming units 32 (specifically, 32a to 32d) that form images having a plurality of color components (yellow (Y), magenta (M), cyan (C), and black (K) in the present exemplary embodiment), a belt-shaped intermediate transfer body 40 that transfers (primarily transfers) and holds each color component image formed by each image forming unit 32 in turn, and a secondary transfer device (collective transfer device) 50 that secondarily transfers (collectively transfers) each color component image transferred to the intermediate transfer body 40 to a medium (paper or a film). In FIG. 3, the reference sign 60 is an operation panel for operating the image forming device.

### Image Forming Unit

In the present exemplary embodiment, each of the image forming units 32 (32a to 32d) has each drum-shaped photoreceptor 33, and around each photoreceptor 33, a charging device 34 that charges the photoreceptor 33, such as a corotron and a transfer roll, an exposure device 35 that writes an electrostatic latent image on the charged photoreceptor 33, such as a laser scanning device, a developing device 36 that develops the electrostatic latent image written on the photoreceptor 33 with each of YMCK color component toners, a primary transfer device 37 that transfers a toner image on the photoreceptor 33 to the intermediate transfer body 40, such as a transfer roll, and a photoreceptor cleaning device 38 that removes a residual toner on the photoreceptor 33 are respectively arranged.

In addition, the intermediate transfer body 40 is hung on a plurality of (three, in the present exemplary embodiment) tension rolls 41 to 43. For example, the tension roll 41 is used as a drive roll driven by a drive motor (not shown) and is circulated and moved by the drive roll. Further, an intermediate transfer body cleaning device 45 for removing a residual toner on the intermediate transfer body 40 after secondary transfer is provided between the tension rolls 41 and 43.

### Secondary Transfer Device (Collective Transfer Device)

Further, in the secondary transfer device (collective transfer device) 50, for example, a transfer roll 55 is pressure-welded and arranged at a part facing the tension roll 43 of the intermediate transfer body 40, and the tension roll 43 of the intermediate transfer body 40 is formed as a facing roll 56 forming a facing electrode of the transfer roll 55. Herein, in the present example, the transfer roll 55 has a configuration where an elastic layer, in which carbon black is mixed with urethane foam rubber and EPDM, is coated around a metal shaft. A transfer voltage from a transfer power supply (not shown) is applied to the facing roll 56 (also serving as the tension roll 43 in the present example) via a conductive power supply roll (not shown). On the other hand, a predetermined transfer electric field is formed between the transfer roll 55 and the facing roll 56 by grounding the transfer roll 55, and a nipping region of the intermediate transfer body 40 nipped between the transfer roll 55 and the facing roll 56 functions as a secondary transfer region (collective transfer region) TR. Although the secondary transfer device 50 has an aspect in which the transfer roll 55 is used, the secondary transfer device 50 is not limited thereto. It is evident that a transfer belt module or the like on which a transfer belt is hung may be used as the transfer roll 55, which is one tension roll.

### Fixing Device

The fixing device 70 is a device that has a heating and fixing roll 71 which is driven to be rotatable and which is arranged to be in contact with an image holding surface side of a medium and a pressurizing and fixing roll 72 which is pressure-welded and arranged to face the heating and fixing roll 71 and which rotates to follow the heating and fixing roll 71, that causes an image held on the medium in a fixing region between both the fixing rolls 71 and 72 to pass, and that heats, pressurizes, and fixes the image.

Herein, a heater is mounted in, for example, a roll body of the heating and fixing roll 71, or the roll body is heated by bringing an external heater into contact with a roll body outer peripheral surface. In addition, it is evident that the heater may be added to the pressurizing and fixing roll 72 as necessary. The present example shows an example of rolls configured as a pair, but the invention is not limited thereto. The heating and fixing roll 71 may be selected as appropriate, for example, by configuring a heating and fixing belt in which an electromagnetic induction heating method is adopted.

### Medium Transport System

Further, the medium transport system 80 has a plurality of stages (two stages in the present example) of medium supply containers 81 and 82. A medium supplied from any one of the medium supply container 81 or 82 reaches the secondary transfer region TR from a vertical transport path 83 extending in a substantially vertical direction via a horizontal transport path 84 extending in a substantially horizontal direction. After then, the medium holding the transferred image reaches the fixing region generated by the fixing device 70 via a transport belt 85 and is discharged from the discharge port 86 of the device housing 30 to the first post-processing device 22 (see FIG. 2).

Further, the medium transport system 80 has, in the horizontal transport path 84, a reversible branched transport path 87 that branches from a portion positioned on a downstream side of the fixing device 70 in a medium transport direction. The medium reversed at the branched transport path 87 returns and returns again from the vertical transport path 83 to the horizontal transport path 84 via a transport path 88. An image is transferred to the back surface of the medium in the secondary transfer region TR, and the medium is discharged from the discharge port 86 of the device housing 30 via the fixing device 70. The branched transport path 87 is provided with a branch return transport path 89, which is branched from the middle and through which a reversed medium is transported to a discharge port 86 side.

In addition, the medium transport system 80 is provided with an appropriate number of transport rolls 91 in the transport paths 83, 84, 87, 88, and 89 respectively, in addition to a position aligning roll 90, which aligns the position of the medium and which supplies the medium to the secondary transfer region TR, and a discharge roll 92 at an outlet portion to the discharge port 86 of the horizontal transport path 84. In addition, a manual feeding medium supplier 95 that is capable of supplying a manually fed medium toward the horizontal transport path 84 is provided on an opposite side of the discharge port 86 of the device housing 30.

Components Other than Image Forming Device

The first post-processing device 22 performs post-processing, such as cooling, curl correction, cardboard insertion, and perforation, on a medium on which an image is formed by the image forming device 21 and transports the medium to the interposer 23 in the subsequent stage.

The interposer 23 is a cardboard insertion device that inserts set cardboard into the middle of the transport path.

The static elimination unit 24 performs static elimination of reducing a charging amount of a charged medium through transfer processing by the secondary transfer device 50 of the image forming device 21. Details of the static elimination unit 24 will be described later.

The inspection device 25 receives a medium on which an image is formed by the image forming device 21 from the static elimination unit 24 in the preceding stage and inspects the image formed on the medium, that is, determines whether or not there is an abnormality in the image formed on the medium. Specifically, the inspection device 25 receives image data of an image to be formed on a medium from the image forming device 21, reads the image of the medium transported from the image forming device 21, compares the image of the received image data with the read image, and determines whether the image formed on the transported medium is normal or abnormal.

In a case where the medium on which the image is formed by the image forming device 21 is transported, the stacker 26 accommodates the medium therein.

The second post-processing device 27 performs post-processing on a medium on which an image is formed by the image forming device 21. Specifically, the second post-processing device 27 has at least one or a plurality of functions including a folding function, a cutting function, a bookbinding function, a binding function, a stacking function, an alignment function, a perforation function, and a discharging function with respect to the medium on which the image is formed by the image forming device 21. Herein, the folding function is a function of performing folding processing on a medium. In addition, the cutting function is a function of cutting the top and bottom of a medium formed as a booklet. In addition, the bookbinding function is also called a booklet function and is a function of generating a booklet by bundling a plurality of media. The binding function is called a staple function and is a function of binding a plurality of media using staples. The stacking function is a function of stacking transported media in turn on a discharge tray 27a. The alignment function is also called a tamper/jogger fence function and is a function of aligning a width direction of a medium or the like. The perforation function is called a punching function and is a function of forming punched holes at predetermined places in a medium.

### Necessity of Static Elimination Processing

In the present example, the image forming device 21 performs a series of image forming processing procedures of forming an electrostatic latent image by irradiating the charged photoreceptor 33 with laser light or the like, developing the formed electrostatic latent image with a colorant such as a toner, and performing fixing processing after transferring the developed image to a medium. In particular, in a case where a high-resistance dielectric such as a resin film is used as a medium, a probability of an increase in a charge amount for charging the medium is high. Then, in a case where the front surface of such a medium is charged with, for example, a negative charge, a positive charge is induced on the back surface of the medium through dielectric polarization. As a result, in a case where media stick to each other due to electrostatic attraction and the second post-processing device 27 performs post-processing on the media in a state of being charged, the media may be charged and adhere to each other as the media overlap each other on the discharge tray or a discharge phenomenon with a human body may occur.

Further, in a case where the media as being charged pass through the inspection device 25, noise may be generated in a case of inspection, and inspection results may be erroneous.

For this reason, in the present exemplary embodiment, the static elimination unit 24 for performing static elimination of reducing charged charges on the media is provided in a subsequent stage of the image forming device 21 (a subsequent stage of the interposer 23 in the present example).

### Static Elimination Unit

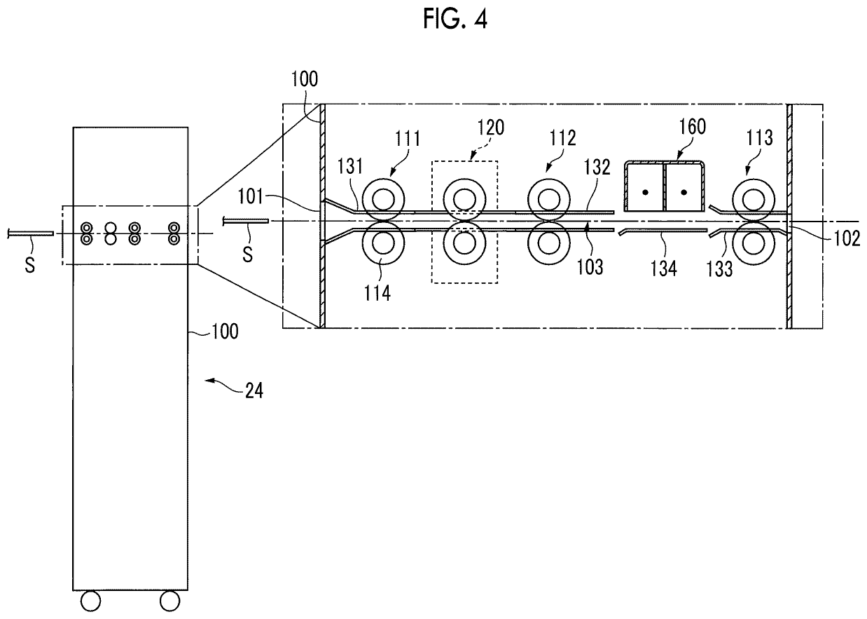

FIG. 4 shows details of the static elimination unit 24 used in the present exemplary embodiment.

In FIG. 4, the static elimination unit 24 has a box-shaped unit housing 100. In the unit housing 100, an inlet 101 connectable to the interposer 23 positioned in a preceding stage and an outlet 102 connectable to the inspection device 25 positioned in a subsequent stage are open, and a medium transport path 103 extending from the inlet 101 toward the outlet 102 positioned in the substantially horizontal direction is provided.

In the present example, in the medium transport path 103, a plurality of sets (three sets in the present example) of transport rolls 111 to 113 in a paired configuration that transport a medium with the medium nipped therebetween are provided with intervals placed from an upstream side in the transport direction of the medium S as appropriate. In the present example, in the medium transport path 103, the transport roll 111 is arranged immediately after the inlet 101, the transport roll 113 is arranged immediately before the outlet 102, and the transport roll 112 is arranged near the center of the medium transport path 103 in the transport direction.

In addition, in the medium transport path 103, a contact-type static elimination device 120 (corresponding to the static elimination device shown in FIGS. 1A to 1C) is provided between the transport rolls 111 and 112, and a non-contact-type static elimination device 160 is provided between the transport rolls 112 and 113.

Further, in the present example, in the medium transport path 103, guide chutes 131 to 133 that are guide members guiding the transport path of the medium S are provided before and after the contact-type static elimination device 120 and the non-contact-type static elimination device 160.

Each of the guide chutes 131 to 133 consists of plate-shaped members in a paired configuration arranged to face the front surface side and the back surface side of the medium S and guides the medium S transported to static elimination regions of the contact-type static elimination device 120 and the non-contact-type static elimination device 160.

In the present example, each of all the transport rolls 111 to 113 has a structure of having a divided roll body 114 divided into a plurality of portions with respect to the axial direction of the rotating shaft, and an opening (not shown) for allowing the divided roll body 114 of each of the transport rolls 111 to 113 to escape is formed in each of the guide chutes 131 to 133.

### Configuration Example of Contact-Type Static Elimination Device

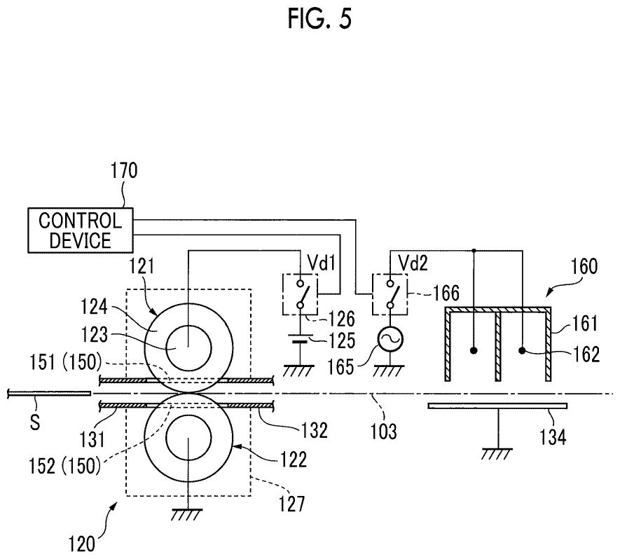

In the present example, the contact-type static elimination device 120 has static elimination rolls 121 and 122 in a paired configuration in a static elimination housing 127 as shown in FIGS. 4 and 5. The static elimination rolls 121 and 122 in a paired configuration each have a metal rotating shaft 123 along an axial direction intersecting the transport direction of the medium S and a roll body 124 continuously extending along the axial direction around the rotating shaft 123 and are rolls that are arranged in a state of being in contact with the roll bodies 124 of each other and that perform static elimination while moving the medium S in a state of being nipped between the roll bodies 124.

In the present example, a drive force from the drive motor (not shown) is transmitted via a drive transmission mechanism (not shown) such as a gear to a static elimination roll of any one of the static elimination roll 121 or 122 in a paired configuration, for example, the static elimination roll 121 so that the static elimination roll 122 comes into contact with the static elimination roll 121 to rotate accordingly.

In addition, in the present example, a static elimination power source 125 is connected to one static elimination roll 121, a static elimination bias Vd1 (a positive direct current voltage is used in the present example) is applied from the static elimination power source 125, and the other static elimination roll 122 is grounded.

Further, the static elimination power source 125 is provided with a switch 126, the switch 126 is turned on and off by a control signal from a control device 170, and the static elimination bias Vd1 is applied from the static elimination power source 125 at a predetermined timing.

In the present example, the roll bodies 124 of the static elimination rolls 121 and 122 have a configuration where an elastic layer, in which carbon black is mixed with urethane foam rubber and EPDM, is coated around the metal rotating shafts 123 and the surface of the elastic layer is coated with, for example, a protective layer such as a fluororesin. Then, the static elimination bias Vd1 from the static elimination power source 125 is applied to the metal rotating shaft 123.

In addition, although the static elimination rolls 121 and 122 are arranged to be in contact with each other even in a case where the medium S does not pass, the invention is not necessarily limited thereto, and the static elimination rolls 121 and 122 may be arranged not to be in contact with each other in a case where the medium S does not pass. However, a gap between the static elimination rolls 121 and 122 may be selected as appropriate in a range in which in a case where the medium S passes between the static elimination rolls 121 and 122, the static elimination rolls 121 and 122 come into contact with the front and back surfaces of the medium S, a contact pressure at a contact region with respect to the medium S ensures transportability of the medium S by the static elimination rolls 121 and 122, and a static elimination operation with respect to the medium S is not impaired.

The static elimination power source 125 may be provided on either the front surface side or the back surface side of the medium S. In an aspect in which the static elimination power source 125 is arranged on the back surface side of the medium S, a static elimination bias or a static elimination current having a polarity opposite to the polarity of a static elimination bias or a static elimination current used in an aspect in which the static elimination power source 125 is arranged on the front surface side of the medium S may be used.

### Regulating Mechanism

In particular, in the present exemplary embodiment, as shown in FIGS. 5 to 7C, the contact-type static elimination device 120 includes a regulating mechanism 150 that is a regulating unit that regulates the moving direction of the medium S in order to prevent the medium S passing through the contact region CN of the static elimination rolls 121 and 122 in a paired configuration from adhering to peripheral surfaces of the static elimination rolls 121 and 122.

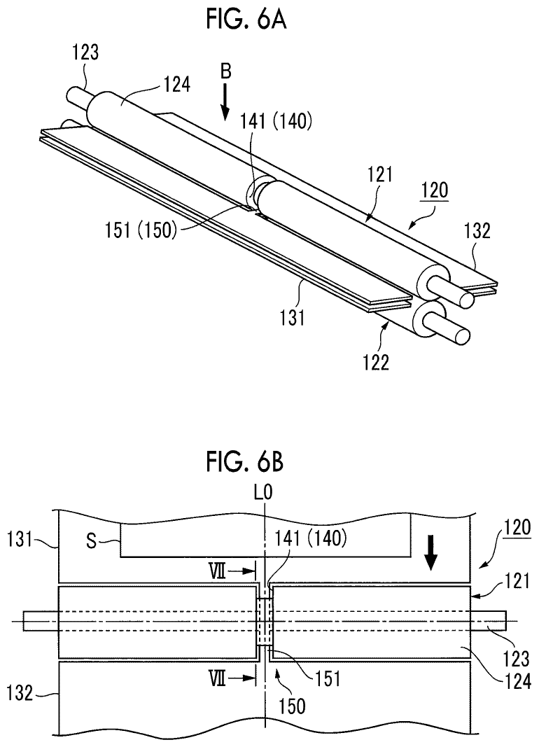

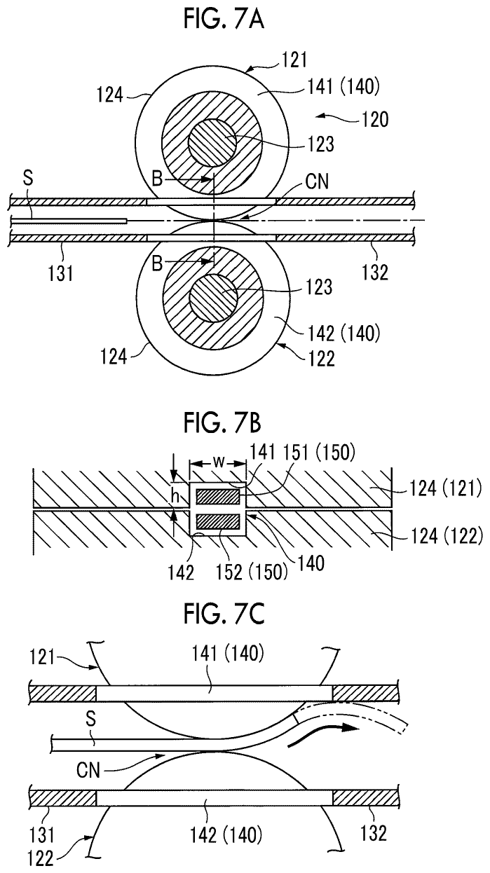

In the present example, as shown in FIGS. 6A and 6B and FIGS. 7A and 7B, the regulating mechanism 150 is provided with bridging members 151 and 152 that pass through a non-contact portion 140 formed at a part of the contact region CN of the static elimination rolls 121 and 122 in a paired configuration in the axial direction and that bridge between the guide chutes 131 and 132 which are arranged before and after the contact region CN interposed therebetween.

In the present exemplary embodiment, as shown in FIG. 6B, the medium S moves with the center in the intersection direction intersecting the moving direction of the medium S as a reference line LO, and the regulating mechanism 150 is provided at a central portion of the static elimination rolls 121 and 122 in a paired configuration in the axial direction such that the reference line LO is included.

### Configuration Example of Non-Contact Portion

In the present example, in the non-contact portion 140, ring-shaped concave grooves 141 and 142 facing each other are formed at central portions of surfaces of the static elimination rolls 121 and 122 in a paired configuration in the axial direction, respectively, and a space portion is secured between the concave grooves 141 and 142. In addition, although sectional shapes of the concave grooves 141 and 142 may be selected as appropriate, in the present example, the concave grooves 141 and 142 are formed to have rectangular shape in cross section having a width dimension w and a depth h as shown in FIGS. 7A and 7B. Herein, although the width dimension w and the depth h of the concave grooves 141 and 142 may be selected such that the bridging members 151 and 152 pass in a non-contact state with inner walls of the concave grooves 141 and 142, in a case where the width dimension w is excessively large, a range in which static elimination processing cannot be directly performed on the medium S expands. Thus, the width dimension w and the depth h may be selected as appropriate, for example, in a range of 1/100 to 1/30 of axial lengths of the roll bodies 124 of the static elimination rolls 121 and 122.

### Configuration Example of Bridging Member

In addition, although sectional shapes of the bridging members 151 and 152 may be selected as appropriate, such as a rectangular shape and a circular shape, in the present example, the bridging members 151 and 152 may be formed in a rectangular shape in cross section (for example, a thick film) to be capable of passing through insides of the concave grooves 141 and 142 in a non-contact manner. As a circular shape in cross section, for example, a thread-like wire rod or the like is used.

In particular, in the present example, the bridging members 151 and 152 are arranged in a state of not protruding from surfaces of the concave grooves 141 and 142 in the contact region CN of the static elimination rolls 121 and 122.

Further, the bridging members 151 and 152 are formed integrally with parts of the guide chutes 131 and 132 positioned therebefore and thereafter. In this case, an aspect in which the bridging members 151 and 152 are formed integrally in advance between the guide chutes 131 and 132 may be adopted, and an aspect in which the bridging members 151 and 152 that are separate members between the guide chutes 131 and 132 are integrally retrofitted and fixed may be adopted.

In addition, although the bridging members 151 and 152 may be configured by either a conductive material or an insulating material, in the present example, the bridging members 151 and 152 are configured by the insulating material. In this case, in a case where the guide chutes 131 and 132 are configured by the insulating material, the bridging members 151 and 152 may be integrally formed. On the contrary, in a case where the guide chutes 131 and 132 are configured by the conductive material, the bridging members 151 and 152 which are integrally formed are also configured by the conductive material, but surfaces of the bridging members 151 and 152 may be coated with a coating layer consisting of the insulating material, or the bridging members 151 and 152 consisting of the insulating material, which are separate members, may be retrofitted.

### Non-Contact-Type Static Elimination Device

In the present exemplary embodiment, as shown in FIGS. 4 and 5, the non-contact-type static elimination device 160 has a static elimination housing 161 that has a channel sectional shape open toward the front surface side of the medium S transported along the medium transport path 103. A plurality of (two in the present example) discharge wires 162 are hung as discharge members in the static elimination housing 161 along a longitudinal direction, and a static elimination power source 165 is connected to the discharge wires 162. While a static elimination bias Vd2 is applied from the static elimination power source 165, the guide chute 134 that partitions a transport path of the medium S is arranged on the back surface side of the medium S.

In addition, the static elimination power source 165 is provided with a switch 166, the switch 166 is turned on and off by a control signal from the control device 170, and the static elimination bias Vd2 is applied from the static elimination power source 165 at a predetermined timing. In this case, although the static elimination power source 165 may apply the static elimination bias Vd2 including at least an alternating current voltage component, a direct current voltage component may be applied as necessary. In addition, the guide chute 134 is grounded and is provided separately from the guide chute 132 or 133 in a paired configuration, but may be provided integrally with a configuring member of one of the guide chute 132 or 133 in a paired configuration.

Although an aspect in which two discharge wires 162 are used is adopted in the present example, without being limited thereto, one or three or more discharge wires 162 may be used. In addition, although a so-called corotron method is adopted in the present example, without being limited thereto, it is evident that an aspect (a so-called scorotron method) in which a grid board that is a control electrode is added to a place facing an opening of the static elimination housing 161 may be adopted. Further, an aspect in which a needle-shaped electrode is provided instead of the discharge wires 162 may be adopted.

### Operation of Static Elimination Unit

### Outline of Static Elimination Processing by Static Elimination Unit

In the present exemplary embodiment, since the medium S on which an image is formed by the image forming device 21 is charged through transfer processing by the secondary transfer device 50 or the like, the medium S in a charged state enters the static elimination unit 24.

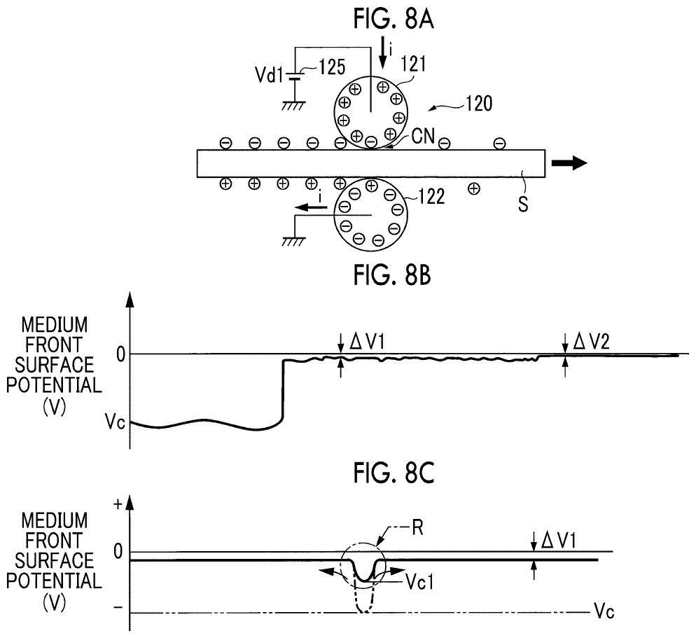

Now, in a case where, for example, the medium S is highly resistant such as a resin film, as shown in FIG. 8A, the front surface of the medium S in the secondary transfer device 50 is charged with negative charges (−), and the back surface of the medium S is charged with positive charges (+) due to dielectric polarization.

In this state, as shown in FIGS. 4 and 5, in a case where the medium S reaches the inlet 101 of the static elimination unit 24, the medium S is first introduced to the contact-type static elimination device 120 along the guide chute 131 and passes through the contact region CN of the static elimination rolls 121 and 122 in a paired configuration. Then, the medium S is introduced to the non-contact-type static elimination device 160 along the guide chute 132, undergoes static elimination processing by the non-contact-type static elimination device 160, and reaches the outlet 102 of the static elimination unit 24 along the guide chute 133.

### Static Elimination Action by Contact-Type Static Elimination Device

In the present example, a static elimination action by the contact-type static elimination device 120 is as follows.

In the present example, as shown in FIG. 8A, the static elimination power source 125 applies the positive static elimination bias Vd1 to the static elimination roll 121 in a case where the contact-type static elimination device 120 performs a static elimination operation. Then, a corona discharge is caused before and after the contact region CN of one static elimination roll 121 and the other static elimination roll 122. In particular, in the present example, since the medium S having a high resistance with a high front surface potential before static elimination enters a void of the contact region CN of the static elimination rolls 121 and 122 on an inlet side, a strong current discharge occurs in a region separated from the contact region CN while being mixed with a weak current discharge in a region close to the contact region CN, and since the medium S with a low front surface potential after static elimination passes through a void of the contact region CN of the static elimination rolls 121 and 122 on an outlet side, the weak current discharge occurs in the region close to the contact region CN. As a result, positive charges (+) applied to the front surface of the charged medium S having a high resistance by an amount determined in advance, and by the amount of the applied charge amount, negative charges (−) on the front surface of the medium S is statically eliminated. In this state, as front surface charges of the medium S reduce, the dielectrically polarized positive charges (+) on the back surface of the medium S also reduce.

In this case, the front surface potential of the medium S which has passed through the contact region CN of the static elimination rolls 121 and 122 in a paired configuration, which has been a charging potential Vc before static elimination, reaches a potential ΔV1 substantially close to 0 as shown in FIG. 8B.

However, in the present example, as shown in FIGS. 6A and 6B, since there is the non-contact portion 140, which does not come into contact with the medium S, at the center of the static elimination rolls 121 and 122 in a paired configuration in the axial direction, as shown in FIG. 8C, a direct static elimination action by the static elimination rolls 121 does not occur at a front surface portion of the medium S, which corresponds to the non-contact portion 140. For this reason, a front surface potential Vc1 of a place R (corresponding to a near center in the width direction intersecting the transport direction of the medium S) of the front surface of the medium S, which corresponds to the non-contact portion 140, reaches a value somewhat lower than the charging potential Vc before static elimination by the amount that a charged charge somewhat disperses in the surroundings as a front surface potential around the medium S reduces to ΔV1.

### Transportability of Medium by Contact-Type Static Elimination Device

In addition, the medium S that passes through the contact-type static elimination device 120 passes through the contact region CN of both at other than the non-contact portion 140 of the static elimination rolls 121 and 122 in a paired configuration and passes between the bridging members 151 and 152 in a paired configuration, which are the regulating mechanism 150, at the non-contact portion 140.

For this reason, in a case where the medium S passes through the contact region CN of the static elimination rolls 121 and 122 in a paired configuration, as shown by an imaginary line in FIG. 7C, winding of the medium S is suppressed by the bridging members 151 and 152 even with behavior of winding a leading end portion of the medium S in a traveling direction around a peripheral surface of any one of the static elimination roll 121 or 122 being caused. Specifically, since the bridging members 151 and 152 in a paired configuration, which pass through the non-contact portion 140, extend to the front and the back with the contact region CN interposed, the moving direction of the medium S at a place of the medium S, which corresponds to the non-contact portion 140, is regulated by the bridging members 151 and 152. For this reason, as shown in FIG. 7C, the medium S that passes through the contact region CN of the static elimination rolls 121 and 122 in a paired configuration moves toward a guide chute 132 side without being wound around the peripheral surface of the static elimination roll 121 or 122.

In addition, in the present example, since the bridging members 151 and 152 in a paired configuration integrally bridge the guide chutes 131 and 132 at the front and the back, the medium S that passes through the static elimination rolls 121 and 122 in a paired configuration is moved by the bridging members 151 and 152 from the guide chute 131 toward the guide chute 132 on a stable movement trajectory.

In the present example, the bridging members 151 and 152 are provided to have a paired configuration, and it is possible to avoid a situation where the medium S is wound around any one of the static elimination roll 121 or 122. However, since the medium S tends to be easily wound around the static elimination roll 122 on the ground side, it is also possible to provide one bridging member 152.

### Another Action by Contact-Type Static Elimination Device

In the present exemplary embodiment, since the bridging members 151 and 152 in a paired configuration are configured by an insulating material, even in a case where the bridging members 151 and 152 have come into contact with the inner walls of the concave grooves 141 and 142 which are the non-contact portion 140, a static elimination action by the static elimination rolls 121 and 122 in a paired configuration is well maintained without the static elimination bias Vd1 applied to the static elimination roll 121 in a paired configuration leaking via the bridging members 151 and 152.

In addition, in the present example, the bridging members 151 and 152 in a paired configuration are arranged in a state of not protruding from the surfaces of the concave grooves 141 and 142, which are the non-contact portion 140, in a range of the contact region CN of the static elimination rolls 121 and 122 in a paired configuration. For this reason, a portion of the medium S, which passes through a place corresponding to the non-contact portion 140, is not pushed up to a radially outer side from a peripheral surface of the roll body 124 by the bridging members 151 and 152, and a contact state between the peripheral surface of the roll body 124 and the medium S around the non-contact portion 140 of the static elimination rolls 121 and 122 in a paired configuration is not impaired. For this reason, a static elimination action by the static elimination rolls 121 and 122 in a paired configuration effectively works in the entire contact region CN.

### Static Elimination Action by Non-Contact-Type Static Elimination Device

In the present example, a static elimination action by the non-contact-type static elimination device 160 is as follows.

In the present example, as shown in FIG. 5, in the non-contact-type static elimination device 160, the static elimination bias Vd2 consisting of an alternating current voltage component is applied between the discharge wires 162 and the static elimination housing 161.

In this case, positive ions (+) and negative ions (−) are mixedly generated from around the discharge wires 162 due to corona discharge and are applied to the front surface of the medium S that passes through the non-contact-type static elimination device 160, and negative charges (−) or positive charges (+), which remain on the front surface of the medium S, are removed. In addition, since the back surface of the medium S is in contact with the grounded guide chute 134, a dielectrically polarized charge on the back surface of the medium S also reduces with the reduction of the charges of the front surface of the medium S.

As a result, the front surface potential of the medium S that has passed through the non-contact-type static elimination device 160 further reduces to a front surface potential ΔV1 of the medium S before passing and reaches a uniform front surface potential ΔV2.

In the present exemplary embodiment, the static elimination unit 24 adopts an aspect in which the contact-type static elimination device 120 and the non-contact-type static elimination device 160 are combined, but it is evident that only the contact-type static elimination device 120 may be used.

In addition, although the bridging members 151 and 152 integrated with the guide chutes 131 and 132 are adopted as the regulating mechanism 150 in the present exemplary embodiment, without being limited thereto, for example, aspects shown by modification embodiment 1 and modification embodiment 2 described below may be adopted.

### Modification Embodiment 1

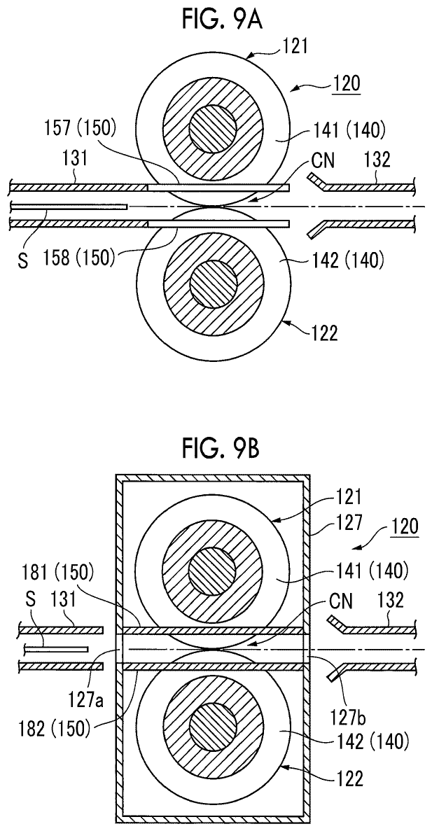

FIG. 9A shows a regulating mechanism according to modification embodiment 1.

In FIG. 9A, as in exemplary embodiment 1, the regulating mechanism 150 passes through the concave grooves 141 and 142 which are the non-contact portion 140 of the static elimination rolls 121 and 122 in a paired configuration, but unlike in exemplary embodiment 1, is configured as the protruding members 157 and 158 in a paired configuration, which do not bridge between the guide chutes 131 and 132 at the front and the back and which are cantilevered by the guide chute 131 on a preceding stage side. The protruding members 157 and 158 in a paired configuration are formed integrally with the guide chute 131 on the preceding stage side, extend toward the guide chute 132 on a subsequent stage side, and have leading end portions arranged close to an inlet portion of the guide chute 132.

In the present example, the inlet portion of the guide chute 132 on the subsequent stage side has an opening larger than a gap between the protruding members 157 and 158 in a paired configuration and has a shape that gradually narrows in the traveling direction of the medium S. For this reason, the position of the medium S that has passed through the contact-type static elimination device 120 is regulated by the protruding members 157 and 158 in a paired configuration, and the medium S is introduced to the guide chute 132 on the subsequent stage side.

### Modification Embodiment 2

FIG. 9B shows a regulating mechanism according to modification embodiment 2.

In FIG. 9B, as in exemplary embodiment 1, the regulating mechanism 150 passes through the concave grooves 141 and 142 which are the non-contact portion 140 of the static elimination rolls 121 and 122 in a paired configuration, but unlike in exemplary embodiment 1, is configured as the bridging members 181 and 182 in a paired configuration, which do not bridge between the guide chutes 131 and 132 at the front and the back and bridge between an inlet-side opening 127a and an outlet-side opening 127b of the static elimination housing 127 of the contact-type static elimination device 120, through which the medium S passes. The bridging members 181 and 182 in a paired configuration are configured, for example, integrally with the static elimination housing 127.

In the present example, after entering the inlet-side opening 127a of the static elimination housing 127 of the contact-type static elimination device 120, the medium S guided by the guide chute 131 on the preceding stage side passes through the contact region CN of the static elimination rolls 121 and 122 in a paired configuration while a position thereof is regulated by the bridging members 181 and 182 in a paired configuration, is discharged from the outlet-side opening 127b of the static elimination housing 127, and moves toward the guide chute 132 on the subsequent stage side.

The bridging members 181 and 182 in a paired configuration bridge between the inlet-side opening 127a and the outlet-side opening 127b of the static elimination housing 127 in the present example, but may be configured as protruding members (not shown) cantilevered by the inlet-side opening 127a of the static elimination housing 127 as in modification embodiment 1.

### Exemplary Embodiment 2

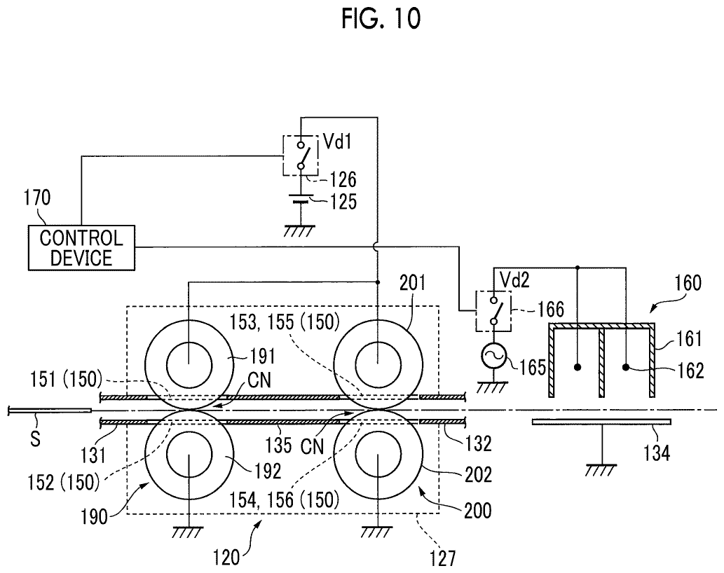

FIG. 10 shows major parts of a static elimination unit according to exemplary embodiment 2.

In FIG. 10, as in exemplary embodiment 1, the static elimination unit 24 has the contact-type static elimination device 120 and the non-contact-type static elimination device 160, but the contact-type static elimination device 120 has a configuration different from the configuration of exemplary embodiment 1. Components that are the same as in exemplary embodiment 1 will be assigned with the same reference signs as in exemplary embodiment 1, and detailed description thereof will be omitted herein.

In the present example, in the contact-type static elimination device 120, a first static eliminator 190 and a second static eliminator 200 are arranged in turn along the medium transport path 103 in the static elimination housing 127. Then, in the present example, an intermediate guide chute 135 that is a guide member which guides the medium S is provided between the first static eliminator 190 and the second static eliminator 200.

In the present example, the first static eliminator 190 has the static elimination rolls 191 and 192 in a paired configuration which is the substantially same configuration as in exemplary embodiment 1 and is provided with the regulating mechanism 150 at a central portion of the static elimination rolls 191 and 192 in the axial direction.

In addition, the second static eliminator 200 has static elimination rolls 201 and 202 in a paired configuration which is the substantially same configuration as in exemplary embodiment 1, and regulating mechanisms 150 are respectively provided at two places biased in the axial direction with a central portion (a portion including the reference line LO) of the static elimination rolls 201 and 202 in the axial direction interposed therebetween.

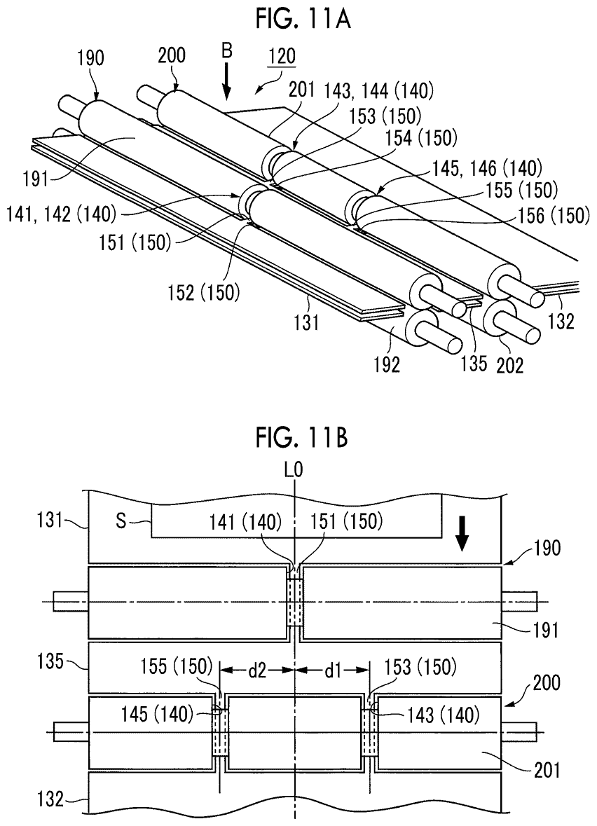

Herein, as shown in FIGS. 11A and 11B, each of the regulating mechanisms 150 of the second static eliminator 200 is arranged to be biased by distances d1 and d2 (d1=d2 in the present example) from the central portion of the static elimination rolls 201 and 202 in a paired configuration in the axial direction, but is selected to be in a range of at least a width dimension of the medium S having a minimum use size.

In the present example, as shown in FIGS. 10, 11A, and 11B, the regulating mechanisms 150 of the first static eliminator 190 are arranged such that the concave grooves 141 and 142, which are the non-contact portion 140, are formed at the central portion of the static elimination rolls 191 and 192 in a paired configuration in the axial direction, and the bridging members 151 and 152, which bridge between the guide chute 131 and the intermediate guide chute 135, pass through the concave grooves 141 and 142, respectively.

In addition, as shown in FIGS. 10, 11A, and 11B, the regulating mechanisms 150 of the second static eliminator 200 are arranged such that the concave grooves 143 to 146, which are the non-contact portion 140, are formed at two places biased in the axial direction, with the central portion of the static elimination rolls 191 and 192 in a paired configuration in the axial direction interposed therebetween and the bridging members 153 to 156, which bridge between the intermediate guide chute 135 and the guide chute 132, pass through the concave grooves 143 to 146, respectively.

In the present exemplary embodiment, the medium S passes through the first static eliminator 190 first, assuming a case where the medium S having a high resistance in a state where a front surface thereof is negatively charged passes through the contact-type static elimination device 120.

In addition, the medium S passes through the contact region CN of the static elimination rolls 191 and 192 in a paired configuration while a position thereof being regulated by the bridging members 151 and 152 in a paired configuration.

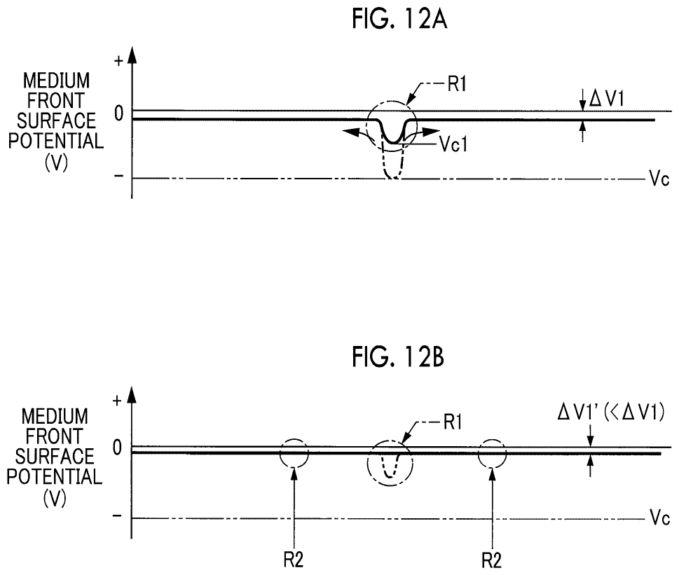

In this case, the front surface potential of the medium S that has passed through the contact region CN of the static elimination rolls 191 and 192 in a paired configuration, which has been the charging potential Vc before static elimination, reaches the potential ΔV1 substantially close to 0 as shown in FIG. 12A. However, the front surface potential Vc1 of a place R1 of the front surface of the medium S, which corresponds to the non-contact portion 140, reaches a value somewhat lower than the charging potential Vc before static elimination by the amount that a charged charge somewhat disperses in the surroundings as a front surface potential around the medium S reduces to ΔV1.

Next, the medium S which has passed through the first static eliminator 190 reaches the second static eliminator 200 after being guided to the intermediate guide chute 135.

Then, the medium S passes through the contact region CN of the static elimination rolls 201 and 202 in a paired configuration while a position thereof being regulated by the bridging members 153 to 156 in a paired configuration.

In this case, the medium S which has passed through the contact region CN of the static elimination rolls 201 and 202 in a paired configuration further receives a static elimination action, and a remaining charge of the medium S is removed. For this reason, since the place R1 (corresponding to near the center in the width direction intersecting the transport direction of the medium S), which corresponds to the non-contact portion 140 of the first static eliminator 190, passes through the contact region CN of the static elimination rolls 201 and 202 in a paired configuration in the second static eliminator 200, a remaining charge of the place, which corresponds to the non-contact portion 140 of the first static eliminator 190, is removed in a case of passing through the second static eliminator 200.

Accordingly, as shown in FIG. 12B, the front surface potential of the medium S reaches a potential ΔV1′ even closer to 0 rather than the front surface potential ΔV1 statically eliminated by the first static eliminator 190. In FIG. 12B, there is no direct static elimination action by the second static eliminator 200 at a place R2 corresponding to the non-contact portion 140 of the second static eliminator 200, but since a static elimination action by the first static eliminator 190 is already received, the static elimination property of the portion is not impaired.

After then, the medium S which has passed through the contact-type static elimination device 120 passes through the non-contact-type static elimination device 160 and receives the same static elimination action as in exemplary embodiment 1.

In the present example, compared to an aspect in which a static elimination action by the contact-type static elimination device 120 is used in exemplary embodiment 1, since a remaining charge of the medium S is more uniformly removed, accordingly, a static elimination performance of the medium S which has passed through the non-contact-type static elimination device 160 is more excellent than in exemplary embodiment 1.

The first static eliminator 190 and the second static eliminator 200 configuring the contact-type static elimination device 120 are incorporated into one static elimination housing 127 in the present exemplary embodiment, but without being limited thereto, it is evident that the first static eliminator 190 and the second static eliminator 200 may be separately provided at individual static elimination housings respectively.

In addition, although the regulating mechanism 150 adopts the bridging members 151 and 152 or 153 to 156 that bridge between the guide chutes 131 and 135 at the front and the back or between the guide chutes 135 and 132 in the present example, without being limited to the aspects, it is evident that for example, the same aspects as in modification embodiments 1 and 2 may be adopted.

Further, although the second static eliminator 200 includes the regulating mechanisms 150 at two places in the present example, without being limited thereto, the regulating mechanism 150 may be at one place or may be at a plurality of places such as three or more places.

### Supplementary Note

(((1)))

A static elimination device comprising:
static elimination rolls in a paired configuration that respectively have roll bodies continuously extending along an axial direction intersecting a moving direction of a medium and that eliminate static electricity by moving the medium in a nipped state;
a static elimination power source that applies a static elimination voltage to at least one static elimination roll of the static elimination rolls in the paired configuration; and
a regulating unit that passes through a non-contact portion formed at a part of a contact region of the static elimination rolls in the paired configuration in the axial direction and that extends to a front and a back in the moving direction of the medium to regulate the moving direction of the medium.
   (((2)))

The static elimination device according to (((1))),
wherein the regulating unit is a bridging member that bridges between fixing units at the front and the back with the contact region of the static elimination rolls in the paired configuration interposed between the fixing units.
   (((3)))

The static elimination device according to (((2))),
wherein the fixing units consist of guide members in a paired configuration that guide a movement path of the medium, and the bridging member is configured integrally with the guide members in the paired configuration.
   (((4)))

The static elimination device according to any one of (((1))) to (((3))),
wherein the regulating unit has ring-shaped concave grooves facing each other in parts of surfaces of the static elimination rolls in the paired configuration in the axial direction respectively and passes through the non-contact portion between the concave grooves of the static elimination rolls in the paired configuration.
   (((5)))

The static elimination device according to (((4))),
wherein the concave grooves each have a rectangular shape in cross section.
   (((6)))

The static elimination device according to (((4))),
wherein the regulating unit is arranged in a state of not protruding from surfaces of the concave grooves in a range of the contact region of the static elimination rolls in the paired configuration.
   (((7)))

The static elimination device according to any one of (((1))) to (((6))),
wherein the regulating unit is configured by an insulating material.
   (((8)))

The static elimination device according to any one of (((1))) to (((7))),
wherein the regulating unit is configured to have a rectangular shape in cross section or a circular shape in cross section.
   (((9)))

The static elimination device according to any one of (((1))) to (((8))),
wherein the regulating unit is provided in a region through which all usable media pass.
   (((10)))

The static elimination device according to (((9))),
wherein the medium moves with a center in an intersection direction intersecting the moving direction of the medium as a reference line, and
the regulating unit is arranged at a place including the reference line.
   (((11)))

The static elimination device according to any one of (((1)) to (10))),
wherein in an aspect in which a plurality of sets of the static elimination rolls in the paired configuration are provided in the moving direction of the medium, and
each set of the static elimination rolls in the paired configuration is provided with the regulating unit, and the regulating unit of each set is arranged to be biased in a direction intersecting the moving direction of the medium.
   (((12)))

A medium processing system comprising:
a processing unit configured to:
   perform processing that involves charging on a moving medium, and
the static elimination device according to any one of (((1))) to (((11))) that eliminates static electricity by passing the medium therethrough.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A static elimination device comprising:
static elimination rolls in a paired configuration that respectively have roll bodies continuously extending along an axial direction intersecting a moving direction of a medium and that eliminate static electricity by moving the medium in a nipped state;
a static elimination power source that applies a static elimination voltage to at least one static elimination roll of the static elimination rolls in the paired configuration; and
a regulating unit that passes through a non-contact portion formed at a part of a contact region of the static elimination rolls in the paired configuration in the axial direction and that extends to a front and a back in the moving direction of the medium to regulate the moving direction of the medium.

2. The static elimination device according to claim 1,
wherein the regulating unit is a bridging member that bridges between fixing units at the front and the back with the contact region of the static elimination rolls in the paired configuration interposed between the fixing units.

3. The static elimination device according to claim 2,
wherein the fixing units consist of guide members in a paired configuration that guide a movement path of the medium, and the bridging member is configured integrally with the guide members in the paired configuration.

4. The static elimination device according to claim 1,
wherein the regulating unit has ring-shaped concave grooves facing each other in parts of surfaces of the static elimination rolls in the paired configuration in the axial direction respectively and passes through the non-contact portion between the concave grooves of the static elimination rolls in the paired configuration.

5. The static elimination device according to claim 4,
wherein the concave grooves each have a rectangular shape in cross section.

6. The static elimination device according to claim 4,
wherein the regulating unit is arranged in a state of not protruding from surfaces of the concave grooves in a range of the contact region of the static elimination rolls in the paired configuration.

7. The static elimination device according to claim 1,
wherein the regulating unit is configured by an insulating material.

8. The static elimination device according to claim 1,
wherein the regulating unit is configured to have a rectangular shape in cross section or a circular shape in cross section.

9. The static elimination device according to claim 1,
wherein the regulating unit is provided in a region through which all usable media pass.

10. The static elimination device according to claim 9,
wherein the medium moves with a center in an intersection direction intersecting the moving direction of the medium as a reference line, and
the regulating unit is arranged at a place including the reference line.

11. The static elimination device according to claim 1,
wherein in an aspect in which a plurality of sets of the static elimination rolls in the paired configuration are provided in the moving direction of the medium, and
each set of the static elimination rolls in the paired configuration is provided with the regulating unit, and the regulating unit of each set is arranged to be biased in a direction intersecting the moving direction of the medium.

12. A medium processing system comprising:
a processing unit configured to:
perform processing that involves charging on a moving medium; and
the static elimination device according to claim 1 that eliminates static electricity by passing the medium therethrough.

13. A medium processing system comprising:
a processing unit configured to:
perform processing that involves charging on a moving medium; and
the static elimination device according to claim 2 that eliminates static electricity by passing the medium therethrough.

14. A medium processing system comprising:
a processing unit configured to:
perform processing that involves charging on a moving medium; and
the static elimination device according to claim 3 that eliminates static electricity by passing the medium therethrough.

15. A medium processing system comprising:
a processing unit configured to:
perform processing that involves charging on a moving medium; and
the static elimination device according to claim 4 that eliminates static electricity by passing the medium therethrough.

16. A medium processing system comprising:
a processing unit configured to:
perform processing that involves charging on a moving medium; and
the static elimination device according to claim 5 that eliminates static electricity by passing the medium therethrough.

17. A medium processing system comprising:
a processing unit configured to:
perform processing that involves charging on a moving medium; and
the static elimination device according to claim 6 that eliminates static electricity by passing the medium therethrough.

18. A medium processing system comprising:
a processing unit configured to:
perform processing that involves charging on a moving medium; and
the static elimination device according to claim 7 that eliminates static electricity by passing the medium therethrough.

19. A medium processing system comprising:
a processing unit configured to:
perform processing that involves charging on a moving medium; and
the static elimination device according to claim 8 that eliminates static electricity by passing the medium therethrough.

20. A medium processing system comprising:
a processing unit configured to:
perform processing that involves charging on a moving medium; and
the static elimination device according to claim 9 that eliminates static electricity by passing the medium therethrough.
